(19) United States
(12) Patent Application Publication
(10) Pub. No.: US 2025/0104230 A1
(43) Pub. Date: Mar. 27, 2025

(54) PLANT DISEASE DETECTION AT ONSET STAGE

(71) Applicant: BASF AGRO TRADEMARKS GMBH, Ludwigshafen (DE)

(72) Inventors: Priyamvada SHANKAR, Köln (DE); Sayan MUKHOPADHAYA, Köln (DE)

(21) Appl. No.: 18/832,403

(22) PCT Filed: Jan. 27, 2023
(86) PCT No.: PCT/EP2023/051986

§ 371 Date: Jul. 23, 2024

(30) Foreign Application Priority Data
Jan. 28, 2022 (EP) 22154052.9

(51) Int. Cl. G06T 7/00; A01G 7/06; B64G 1/10

(52) U.S. Cl. CPC G06T 7/0012; A01G 7/06; B64G 1/1028; G06T 2207/10036; G06T 2207/20081; G06T 2207/30188

(57) ABSTRACT

The present invention relates to an plant disease detection at onset stage. Provided is a computer-implemented method for determining an onset and/or onset time of a plant (12) disease in agriculture. The method comprises providing (S110) first data including field data (14) associated with the plant's cultivation and weather data (16) associated with a location where said plant is cultivated to a computer model (20). The method further comprises determining (S120), by using said computer model (20), a plant disease presence prediction for said plant and its infestation with said plant disease and determining, from said computer model (20) output including said plant disease presence prediction and second data (18) including one or more vegetation indices associated with said plant, the onset and/or onset time to which said plant disease is expected to onset at said plant, by using the plant disease presence prediction and a change in the one or more vegetation indices.

### TECHNICAL FIELD

The present application relates to computer-aided agricultural plant treatment. In particular, the present application relates to a method and an apparatus for determining an onset and/or onset time of a plant disease in agriculture. Further, the present application relates to the use of a computer model to predict a plant disease.

### BACKGROUND OF THE INVENTION

In agriculture, cultivated plants, crops, or the like, can be affected by diseases occurring between seeding and harvest, which may diminish the yield. Thereby, plant disease occurrence is mainly driven by three factors, namely the host plant, which affects plant specific vulnerabilities, the pathogen, which represents a disease causing agent, and the environmental conditions, which may comprise disease favoring weather or the like. Mainly these three factors drive disease occurrence, wherein the development of the disease is a dynamic process between these factors. This complex relationship of factors alone makes plant disease management a challenge. However, plants can be kept healthy with plant protection measures or plant treatment, such as the application of plant protection agents, pesticides, or the like. Nevertheless, it is a challenge, for example, to determine the most appropriate time for plant protection measures, to identify the appropriate plant protection agent, to determine an optimal quantity of the plant protection agent, etc.

For this purpose, a computer model can be used to predict a plant disease, e.g. a severity of a plant disease or the like, in order to schedule plant treatment to control the plant disease. When such a computer model is used in a field or crop management system used by, for example, a farmer to assist in plant care and/or treatment, the system provides a rather inexact and sometimes too late time at which the device then informs, e.g. the farmer, about the crop disease and/or provides an action instruction for crop treatment and/or disease control.

### SUMMARY OF THE INVENTION

Therefore, there may still be a need to improve prediction accuracy when using a computer model to predict a plant disease. The object of the present invention is solved by the subject matter of the independent claims, wherein further embodiments are incorporated in the dependent claims.

In a first aspect, there is provided a computer-implemented method for determining an onset and/or onset time of a plant disease in agriculture. The method comprises providing first data including field data associated with the plant's cultivation and weather data associated with a location where said plant is cultivated to a computer model, and determining, by using said computer model, a plant disease presence prediction for said plant and its infestation with said plant disease. Further, the method comprises determining, from said computer model output including said plant disease presence prediction and second data including one or more vegetation indices associated with said plant, the onset and/or onset time to which said plant disease is expected to onset at said plant, by using the disease presence prediction and/with a change in the one or more vegetation indices, in particular by aligning the disease presence prediction with a change in the one or more vegetation indices.

In other words, there is provided a computer-implemented method for detecting a plant disease in agriculture in an onset stage of the plant disease. The method comprises providing first data including field data associated with the plant's cultivation and weather data associated with a location where said plant is cultivated to a computer model, and determining, by using said computer model, a plant disease presence prediction for said plant and its infestation with said plant disease. Further, the method comprises determining, from said computer model output including said plant disease presence prediction and second data including one or more vegetation indices associated with said plant, the onset and/or onset time to which said plant disease is expected to onset at said plant, by using the disease presence prediction and/with a change in the one or more vegetation indices, in particular by aligning the disease presence prediction with a change in the one or more vegetation indices.

The inventors have found that vegetation indices, which may be any indicator, e.g. graphical indicator, that can be used to analyze the vegetation at the field, sections thereof and/or the plant, can be used as an auxiliary feature to detect early onset of the plant disease together with the plant disease presence prediction, or plant disease presence predictions over time, or disease severity predictions over time, derived from the computer model based on the first data. In other words, the inventors have found the methods, systems, etc. herein to estimate the appearance of plant disease at an early stage to take efforts to control its spread by considering the available vegetation index or indices and analyses the behavior of the vegetation in a field before the first observation of disease. Accordingly, based on the combination of both computer model output and changes in vegetation indice(s), the method allows to predict early signs of disease progression. In other words, the method estimates the onset of the plant disease based on both the trend of the model-predicted disease progression and the vegetation index or indices. This relies on three kinds of data: In situ data or field (collected) data, weather data and the vegetation index or indices.

In this way, farmers can be warned early, even in advance or at least at an early stage of disease occurrence and/or infestation, so that there is a good chance of control of the plant disease. This has a positive effect on field and crop management, e.g. sustainability or environment, as equipment for crop treatment has to be operated less due to low infestation, less pesticide or the like needs to be applied, etc. If the onset or onset time is determined, a field and/or plant management system can provide information about the on setting plant disease to the farmer and/or determine a treatment schedule or plan for the plant's treatment and/or treatment against the disease. The field and/or plant management may also comprise instructing or controlling a robotic vehicle, an unmanned aerial vehicle, etc., and/or sending messages to the farmer. Further, a good control of the plant disease at an early stage allows to have a good or maximum yield, at least compared to an infested plant.

It is noted that the onset and/or onset time of the plant disease may be determined and/or used in a server or cloud environment, which may be or may be part of the above-mentioned field or plant management system, wherein the onset and/or onset time can be used, e.g. sent as a message etc., to inform the farmer about the onset of the plant disease, whereupon the farmer can imitate countermeasures, like plant treatment, to control the plant disease or its spread. Alternatively or additionally, the onset and/or onset time of the plant disease may be determined and/or used in a client-device, which may be located at a farmer's site.

As used herein, a plant disease may be any undesirable or devastating plant disease and/or devastating crop disease. By way of example, the plant disease may be caused by a fungus called Puccinia striiformis, wherein other disease are conceivable, at least if these cause a visible effect on the physiology of plants such as reduction in biomass, decrease in Leaf Area Index (LAI), lesions caused by infections, destruction of pigments and wilting, or the like. Such a plant disease may have an impact on e.g. the yield of the plant.

The plant to be observed and/or treated may be any cultivated plant, which may be also referred to as a crop, such as wheat, rice, maize, potato, soya bean, or the like. Preferably, the plant shows, in the onset of the plant disease and/or infestation a visible effect on the physiology of plants, reduction in biomass, decrease in Leaf Area Index (LAI), lesions caused by infections, destruction of pigments and wilting, or the like.

The computer model may be a regression model, which is suitable, because plant disease severity is a continuous variable. The computer model may be trained with training data prior to its use. The computer model may be implemented by a tree based algorithm, such as XGBoost, Random Forest, CatBoost, or the like. For example, the computer model may be used to model a disease severity over time as a value between 0-1 with 0 being no disease and 1 being the highest infestation.

The weather data may, for example, comprise observed data from one or more weather stations and/or modelled data, wherein these data may comprise one or more parameters such as air temperature (maximum, minimum and average), air temperature at a height of 5 cm, cloud cover percentage, dew point, precipitation (mm and duration), relative humidity (maximum, minimum and average), sunshine duration in hours and wind speed (maximum, minimum and average), or the like. For example, plant diseases may have a correlation with the behavior of mean and maximum temperature of a day, precipitation, sunshine duration and other weather parameters, having an impact on the progression of the disease on the plant.

The location where the plant is cultivated may be known from the field data, from scouting, in-situ observation, a farmer's record provided, or the like, and may be indicated in geo-coordinates or the like.

According to an embodiment, the using the plant disease presence prediction and/with a change in the one or more vegetation indices, in particular the aligning, may comprise applying an estimation rule, according to which is applied: if there is a presence of the plant disease in the plant disease presence prediction and if there is a change, e.g. an increase or drop etc., in the one or more vegetation indices, determine this as the onset and/or onset time of said plant disease. In other words, the method signals the onset of the plant disease if it is determined a presence in the computer model's plant disease presence prediction and there is determined a change, e.g. an increase or drop, in the vegetation index or indices. Thus, the onset of the plant disease can be determined quite accurately and accordingly an early warning to a farmer can be generated and provided.

In yet other words, according to an embodiment, the using the plant disease presence prediction and/with a change in the one or more vegetation indices, in particular the aligning, may comprise applying an estimation rule defining: if there is a presence of the plant disease in the plant disease presence prediction and if there is a change in the one or more vegetation indices, signal determination of onset of said plant disease.

In an embodiment, the estimation rule may be expressed as

$$\frac{d ( predictions )}{dt} > 0 * \frac{d ( remotesensingindices )}{dt} < 0 ,$$

wherein

$$\frac{d ( predic tions )}{dt}$$

is a gradient of the computer model prediction

$$\frac{d ( remotesensingindices )}{dt}$$

is a gradient of the one or more vegetation indices, and * is a logical AND plant disease can be determined quite accurately and accordingly an early warning to a farmer can be generated and provided.

According to an embodiment, the using the plant disease presence prediction and/with a change in the one or more vegetation indices, in particular the aligning, may comprise convoluting, in the plant disease presence prediction comprising multiple plant disease presence predictions over time, a differential operator over the one or more vegetation indices, and determining a point with the maximum gradient as the onset and/or onset time of said plant disease. For example, considering the time series of these predictions it could be observed that the computer model shows a spike in the plant disease presence predictions a few days before the actual disease observation. So an efficient method to detect this spike can be applied and then a window is fixed around the spike which could be used as an observation window to detect the onset of the disease severity. To detect these spikes a differential operator with a length twice that of the actual series is convoluted over the remote sensing index, the point at which the maximum spike occurred is the point with the maximum gradient. This approach works well in detecting the computer model spikes.

In an embodiment, the one or more vegetation indices may comprise one or more of normalized difference vegetation index, NVDI, normalized difference red edge index, NDRE, and normalized difference water index, NDWI. As described above, these vegetation indices are graphical indicators that can be used to analyze remote sensing data, e.g. measurements to asses whether or not the field, field sections thereof and/or the plant observed contains live green vegetation etc., and are good indicators of vegetation condition and amount. Of course, any vegetation index that indicates the vegetation condition and/or amount, can be used in this context. For example, healthy plants are usually green because they absorb blue and red light and have higher reflectance of near-infrared (NIR) and green in the visible wavelength. However, when the plant is diseased the spectral reflectance and absorption is basically reversed. Therefore, the one or more vegetation indices can be used, also as a supplement to manual scouting, acting as a diagnostic tool that can detect and quantify plant diseases in an automated an objective manner versus manual scouting which is less efficient and subjective to human judgement.

According to an embodiment, the second data and/or the one or more vegetation indices may be derived from remote sensing data. In other words, the data used herein for determining the onset and/or onset time of the plant disease may specifically comprise in-situ data or field data, weather data and remote sensing data. This allows such valuable information of fields, i.e. the one or more vegetation indices, to be obtained without any physical contact or extensive manual labor. Such non-invasive scouting may be carried out, for example, by using one or more optical sensors. Capabilities of optical sensors combined with e.g. a Geographical Information Systems (GIS), Internet-of-things (IoT) allows for thus obtained scouting results to be incorporated into precision agriculture. Optical sensors used for disease detection may comprise an RGB (Red, Green and Blue) sensor, a multi and hyperspectral reflectance sensor, a thermal sensor and/or fluorescence imaging. In more detail, an RGB sensor may be configured to capture digital images of plant diseases with the red, green, and blue channels wherein such images may be processed with a machine learning and/or computer vision techniques to quantify crop diseases. Further, with a multi and hyperspectral reflectance sensor, disease detection is based on the amount of emitted light from crop canopy in specific wavelengths of the electromagnetic spectrum (EMS). Exemplary types of spectral sensors, multi spectral and hyperspectral, are based on the number of bands and their narrowness with EMS. Multi spectral sensors result in imagery with e.g. 3-10 bands such as red, green, blue, near-infrared (NIR) and Short-wave infrared. Hyperspectral on the other hand has multiple narrower bands (100-1000 bands). Instead of monitoring reflectance from individual bands they can be combined in the form of the above-described vegetation indices (VI) too. Vegetation indices like normalized difference vegetation index (NDVI), normalized difference red edge index (NDRE), normalized difference water index (NDWI) etc. are all good indicators of vegetation condition and amount. Therefore, such spectral sensors are considered to be valuable for site-specific diseases management. Further, a thermal sensor is configured to measure the radiation emitted from crop canopy and convert it into temperature. Since this temperature is dependent on the evaporation ability and soil water status of the plant, presence of diseases is shown to have an impact and can be detected with thermal imagery. Furthermore, fluorescence imaging is configured to capture photosynthetic capabilities of the plant and diseases may be estimated as a function of difference in the photosynthetic activity of healthy and disease stressed plants.

Remote sensing has a capability to provide near real time information at both field scale and large scale, an thus enable sustainable plant protection. As used herein, remote sensing may be understood as a process of detecting and monitoring the physical characteristics of an area by measuring its reflected and emitted radiation at a distance, typically from satellite or aircraft, unmanned aerial vehicle (UAV), or the like, provided that these provide measurements and/or images suitable to be analyzed to derive a vegetation index. Sensors and/or cameras on satellites and airplanes, UAVs or the like may take measurements, images, etc. of large areas on the Earth's surface.

In an embodiment, the remote sensing data may be obtained from one or more satellites and/or one or more aircrafts. Remote sensing in this regard my rely on the e.g. optical sensors mounted on satellites and/or aircrafts to measure the amount of light reflected and/or emitted from plants at specific wavelengths to estimate the chlorophyll content which is an indication of plant health. As described above, healthy plants are usually green because they absorb the blue and red light and have higher reflectance of near-infrared (NIR) and green in the visible wavelength. However, when the plant is diseased the spectral reflectance and absorption is basically reversed. Therefore, remote sensing can be a supplement to manual scouting, acting as a diagnostic tool that can detect and quantify plant diseases in an automated and objective manner versus manual scouting which is less efficient and subjective to human judgement. For example, satellites used as a data source for the remote sensing may comprise Sentinel-2, Airbus OneAtlas, Landsat 7 or 8, or the like.

According to an embodiment, the remote sensing data may comprise one or more multispectral images. For example, multispectral sensors result in imagery with 3-10 bands such as red, green, blue, near-infrared (NIR) and short-wave infrared. Instead of monitoring reflectance from individual bands they can be combined in the form of vegetation Indices (VI).

In an embodiment, the field data may comprise information about one or more of a growth stage of the plant, days after sowing the plant, a planting month of the plant, a planting day of year, a location where the plant is cultivated, and previous crop. These data have been shown individually, in groups, or in combination to be particularly useful for early detection of the onset of plant disease.

According to an embodiment, the weather data may comprise information about one or more of wind speed, average wind speed, relative humidity, average relative humidity, maximum relative humidity, air temperature, maximum air temperature, precipitation, and minimum air temperature at 5 cm height. These data have been shown individually, in groups, or in combination to be particularly useful for early detection of the onset of plant disease.

In an embodiment, the computer model may be trained with training data fitting the first data without including training data fitting to the second data, prior to the computer model's use for plant disease presence prediction. In other words, the inventors have found to not use the one or more vegetation indices as a feature to train the computational model but to use them as an auxiliary feature to the plant disease presence prediction model to determine early onset of disease. As described herein, the computational model may be trained with only e.g. temporal, geometric, hyperlocal weather, previous crop and/or growth stage features, and/or other data described herein other than vegetation index-related or remote sensing data, and the computer model is used to determine when the model starts predicting the presence of disease and to observe the one or more vegetation indices, such as NDVI and NDRE, to see when they start changing, e.g. increasing or dropping. With the above-described estimation rule based on the trend of the model-predicted disease presence and/or progression and the one or more vegetation indices and/or remote sensing indices the onset of the disease and/or disease severity may be estimated. Omitting vegetation indices and/or remote sensing data when training the computer model has surprisingly resulted in a particularly accurate prediction or estimate of disease onset. In addition, the training effort is lower due to limited training data.

According to an embodiment, the first data and/or the second data may be provided in tabular structure. The first data may be selected for their importance from: growth stage of the considered crop, latitude of crop cultivation, country of crop cultivation, maximum air temperature of and/or during crop cultivation, planting month of the considered crop, planting date of the considered crop, planting day of year of the considered crop, previous crop of a field of the considered crop, planting year of the considered crop, days after sowing of the considered crop, trial year (i.e. year the trial was conducted), minimum air temperature of and/or during crop cultivation, minimum air temperature at a height of 5 cm above the ground of the considered crop, precipitation duration, average cloud cover percentage during crop cultivation, maximum dew point during crop cultivation, maximum wind speed during crop cultivation, average wind speed during crop cultivation, minimum relative humidity during crop cultivation, maximum relative humidity during crop cultivation, average relative humidity during crop cultivation, best precipitation, sunshine duration during crop cultivation. For example, weather may crucial for disease occurrence and progress, so that their importance is rather high for selection. By selecting a set of features from the above list, the prediction of the computer model may be further improved.

In an embodiment, the method may further comprise providing the determined onset and/or the onset time as output data to be used for a plant protection or treatment trigger, alarm and/or schedule. For example, a plant protection agent spraying time point or time window may be derived from such a prediction of the onset and/or onset time for disease management. By way of example, the onset prediction may be used to specify a plant protection agent to be used. For this purpose, a suitable computer model, or data obtained by a database, etc., may be used. This can further improve quality of the plant treatment. In an example, the onset prediction may be used as a trigger to inform a farmer, e.g. through a message, an alert, etc., and/or to instruct, the farmer user carry out certain actions for crop protection, e.g. at a certain time. Further, by way of example, the onset protection may be used to generate a control data set adapted to be provided to a robotic device, e.g. a spraying device, which may, for example, be adapted to automatically carry out the crop treatment and/or to apply e.g. a plant protection agent, a pesticide, etc., at a specific date or time. may be used to determine a crop protection and/or treatment plan to be provided for preventive and/or acute treatment of the crop. The plan may comprise a treatment period or a treatment time. In other words, the use of the onset is capable of finding a suitable or, preferably, the most appropriate treatment timing, such as a spray timing, at which, for example, a plant protection agent or pesticide can be applied in order to at least control, eliminate or prevent the disease, on the one hand, and to require the smallest possible quantities of the plant protection agent or pesticide, on the other hand. The plant protection treatment parameter may therefore also be referred to as optimum treatment and/or application time. This can further improve efficiency in agriculture.

A second aspect of the present application relates to the use of an onset and/or onset time determined by the method according to the first aspect to schedule or plan treatment of a plant in agriculture. For example, a plant protection agent spraying time point or time window may be derived from such a prediction of the onset and/or onset time for disease management. By way of example, the onset prediction may be used to specify a plant protection agent to be used. For this purpose, a suitable computer model, or data obtained by a database, etc., may be used. This can further improve quality of the plant treatment. In an example, the onset prediction may be used as a trigger to inform a farmer, e.g. through a message, an alert, etc., and/or to instruct, the farmer user carry out certain actions for crop protection, e.g. at a certain time. Further, by way of example, the disease protection may be used to generate a control data set adapted to be provided to a robotic device, e.g. a spraying device, which may, for example, be adapted to automatically carry out the crop treatment and/or to apply e.g. a plant protection agent, a pesticide, etc., at a specific date or time. This can further improve efficiency in agriculture.

In a third aspect, there is provided an apparatus for determining an onset and/or onset time of a plant disease in agriculture. The apparatus may be configured to carry out the method according to the first. aspect.

In other words, provided is an apparatus for detecting a plant disease in agriculture in an onset stage of the plant disease.

The apparatus comprises a data processor and a data interface connected to said data processor. The data interface is configured to receive first data including field data associated with the plant's cultivation and weather data associated with a location where said plant is cultivated and second data including one or more vegetation indices associated with said plant; wherein the data processor is configured to carry out a computer model to determine, based on the received first data, a plant disease presence prediction for said plant and its infestation with said plant disease. The data processor is configured to determine, based on said computer model output including said plant disease presence prediction and the second data, the onset and/or onset time to which said plant disease is expected to onset at said plant, by using the disease presence prediction and/with a change in the one or more vegetation indices, in particular by aligning the plant disease presence prediction with a change in the one or more vegetation indices.

A fourth aspect provides a computer program element for determining an onset and/or onset time of a plant disease in agriculture, the computer program, when being executed by a data processor and/or computer device, is adapted for carrying out the method according to the first aspect, and/or to control an apparatus according to the third aspect.

According to a fifth aspect, there is provided a computer-readable storage or transmission medium, which has stored or which carries the computer program element according to the fourth aspect.

A sixth aspect provides a server or cloud environment configured to determine an onset and/or onset time of a plant disease in agriculture according to any one of the above aspects. The server or cloud environment may comprise at least one data processor, at least one data and/or communication interface, preferably configured to provide and/or receive the first and/or second data, namely one or more of the field data, the weather data, and the one or more vegetation indices.

A seventh aspect provides a client device configured to determine an onset and/or onset time of a plant disease in agriculture according to any one of aspects one to four. The client device may comprise at least one data processor, at least one data and/or communication interface, preferably configured to provide and/or receive the first and/or second data, namely one or more of the field data, the weather data, and the one or more vegetation indices.

A eighth aspect provides a system comprising a server or cloud environment according to the fifth aspect and a client device according to the seventh aspect. The system may be a distributed computer system, wherein computational steps may be divided between the distributed parts. Also the above apparatus of the third aspect may be part of the system, and may also be distributed among different entities of the system.

It is noted that embodiments of the invention are described with reference to different subject-matters. In particular, some embodiments are described with reference to method-type claims whereas other embodiments are described with reference to apparatus or device-type or system-type claims. However, a person skilled in the art will gather from the above and the following description that, unless otherwise notified, in addition to any combination of features belonging to one type of subject-matter also any combination between features relating to different subject-matter is considered to be disclosed with this application. Further, all features can be combined providing synergetic effects that are more than the simple summation of the features.

These and other aspects of the present invention will become apparent from and elucidated with reference to the embodiments described hereinafter.

### BRIEF DESCRIPTION OF THE DRAWINGS

Exemplary embodiments of the invention will be described in the following with reference to the following drawings.

FIG. 1 illustrates in a schematic block diagram a principle of determining an onset and/or onset time of a plant disease in agriculture according to the present disclosure.

FIG. 2 illustrates in a schematic block diagram a principle of determining an onset and/or onset time of a plant disease in agriculture utilizing remote sensing.

FIG. 3 illustrates in a schematic block diagram a use case for applying the principle of determining an onset and/or onset time of a plant disease in agriculture according to FIG. 1 or FIG. 2.

FIG. 4 illustrates in a schematic block diagram a use case for applying the principle of determining an onset and/or onset time of a plant disease in agriculture according to FIG. 1 or FIG. 2.

FIG. 5 shows in a flow chart a computer-implemented method for of determining an onset and/or onset time of a plant disease in agriculture according to the present disclosure.

The drawings are merely schematic representations and serve only to illustrate the invention. Identical or equivalent elements are consistently provided with the same reference signs.

### DETAILED DESCRIPTION

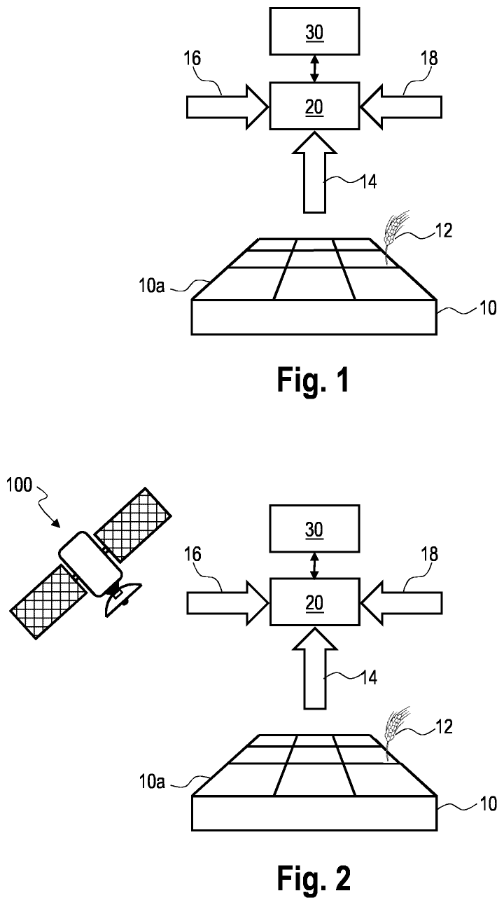

FIG. 1 illustrates in a schematic block diagram a principle of determining an onset and/or onset time of a plant disease in agriculture according to the present disclosure. The principle illustrated in FIG. 1 may be computer-implemented and applied to the methods, apparatuses, devices and systems described herein.

An agricultural field 10, or one or more field sections 10a thereof, or one or more plants 12 grown thereon, is the starting point of the principle. which can be localized e.g. by means of geo-coordinates, data of a farmer, etc. The field 10 or the plant 12 grown thereon may be infested with plant diseases between its sowing and its harvesting, which may reduce or destroy the yield. Determining an onset and/or onset time of a plant disease as described herein may assist in detecting and/or controlling the disease in an early stage, at which, for example, the disease may be easier controllable, to maintain or increase the yield.

As indicated in FIG. 1, the principle of determining the onset and/or onset time of the plant disease, relies on field data 14 associated with the plant's cultivation and weather data 16 associated with a location of the plant 12, i.e. the location of the field 10 or the respective field section 10a, or the like, and vegetation index data 18 indicating a vegetation condition and/or amount. The field data 14 and weather data 16 may be referred to as first data, and the vegetation index data 18 may be referred to as second data.

The field data 14, weather data 16 and vegetation index data 18 are provided to a computer model 20 trained to determine and output a plant disease presence prediction for the plant and its infestation with the plant disease.

The output of the computer model 20 including the above-described plant disease presence prediction, which may comprise disease severity prediction over time, and the vegetation index data 18 is processed by e.g. a data processor 30. The computer model 20 may be run by the data processor 30 or by any other suitable computing means. The data processor 30, and also the computer model 20, may be configured, e.g. via data interface which in FIG. 1 is indicated by an arrow, to receive or provide data, such as computational results, or the above data.

In particular, the output of the computer model 20 including the above-described plant disease presence prediction is aligned with a change in one or more vegetation indices of or derived from the vegetation index data 18 to determine an onset and/or onset time to which said plant disease is expected to onset at said plant.

For example, for the using the plant disease presence prediction and/with a change in the one or more vegetation indices, particularly for the aligning, the data processor 30 may apply an estimation rule, according to which is applied: if there is a presence of the plant disease in the plant disease presence prediction and if there is a change, such as an increase or drop, in the one or more vegetation indices, determine this as the onset and/or onset time of said plant disease. The rule may be implemented in computer instructions.

In other words, the using the plant disease presence prediction and/with a change in the one or more vegetation indices, in particular the aligning, may comprise applying an estimation rule defining: if there is a presence of the plant disease in the plant disease presence prediction and if there is a change in the one or more vegetation indices, signal determination of onset of said plant disease.

Hence, the estimation rule may be expressed as:

$$\frac{d ( predictions )}{dt} > 0 * \frac{d ( remotesensingindices )}{dt} < 0 ,$$

wherein

$$\frac{d ( predic tions )}{dt}$$

is a gradient of the computer model's plant disease prediction,

$$\frac{d ( remotesensingindices )}{dt}$$

is a gradient of the one or more vegetation indices, and * is a logical AND operator.

The field data 14 may comprise information about one or more of a growth stage of the plant, days after sowing the plant, a planting month of the plant, a planting day of year, a location where the plant is cultivated, and previous crop.

The weather data 16 may comprise, for example, observed data from one or more weather stations and/or modelled data, or the like. These may be obtained from a weather station, a weather station network, a database, and may be provided or obtained via an application programming interface (API).

The vegetation index data 18 may comprise the one or more vegetation indices, such as normalized difference vegetation index, NVDI, normalized difference red edge index, NDRE, and normalized difference water index, NDWI, or the like, and may be provided or obtained via an application programming interface (API).

FIG. 2 illustrates in a schematic block diagram the principle of determining an onset and/or onset time of a plant disease in agriculture with utilizing remote sensing to derive the vegetation index data 18 from remote sensing.

In this exemplary embodiment, the remote sensing may utilize satellites or satellite data sources 100, such as Sentinel-2, Airbus OneAtlas, Landsat, 7, Landsat 8, or the like, or aircrafts to acquire sensing data from which the one or more vegetation indices may be derived. For example, the remote sensing may be performed by utilizing an optical sensor of the satellite or aircraft to acquire one or more images of the field 10, the field section 10a and the plant 14. From these images, one or more of the above-mentioned vegetation indices may be determined, e.g. calculated, and provided to the computer model 20. For example, the images acquired by remote sensing are multi-spectral images, with multiple bands, such as red, green, blue, near-infrared (NIR, or short-wave infrared. The individual bands may be combined to determine the vegetation indices.

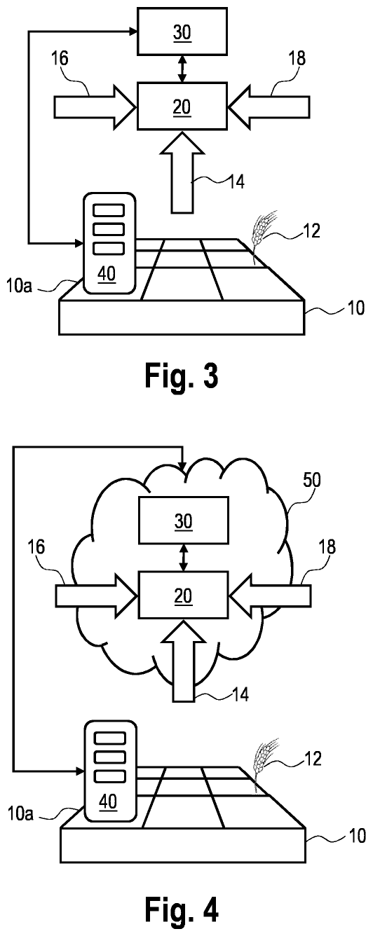

FIG. 3. illustrates a use case in which the determined onset and/or onset time of the plant disease is provided as information for e.g. a farmer. The farmer may utilize a client device 40, such as a computer, any kind of user equipment, such as a smartphone, or the like, configured to receive messages including the onset and/or onset time of the plant disease or to determine the onset and/or onset time of the plant disease according to the principle described above.

For example, the above-described computer model 20 and data processor 30 may be part of the client device 40. In this case, the client device 40 may comprise a data and/or communication interface configured to obtain, e.g. receive, at least the vegetation index data 18 and the weather data 16, e.g. via a communications network, such as the Internet. It is noted that the vegetation index data 18 may also be determined by the client device 18 based on the sensing data which may derived from remote.

The client device 40, e.g. the data processor 30, may be configured to run a suitable application with a graphical user interface and configured to assist in deriving the field data 16, which may be input manually or via a scouting application or at least in part received from remote, the weather data 16, and the vegetation index data 18. The client device 40 may be configured to control the computer model 20 and the data processor 30 to determine the onset and/or onset time of the plant disease as described above.

The determined onset and/or onset time may then be signaled, e.g. via a display, i.e. the GUI, a loudspeaker, etc. to the farmer, i.e. the user of the client device 40. In some embodiments, the determined onset and/or onset time may be used to determine a treatment plan for the plant 12 and/or the field 10 or its field section(s) 10a.

FIG. 4 illustrates illustrates in a schematic block diagram another use case in which the determined onset and/or onset time of the plant disease is provided as information for e.g. a farmer. Unlike FIG. 3, in this exemplary embodiment, the computer model 20 and the data processor 30 are arranged in a server or cloud environment 50, which is thus configured to determine the onset and/or onset time of the plant disease as described above. Further, the server or cloud environment 50 may use the determined onset and/or onset time to determine a treatment plan for the plant 12 and/or the field 10 or its field section(s) 10a. The latter may be provided to the client device 40.

For example, the field data 14 may be obtained, e.g. received via a communication interface of the a server or cloud environment 50, from the client device 40.

It is noted that some tasks to determine the onset and/or onset time of the plant disease and the further processing of e.g. determining a plant treatment plan, signaling the farmer, etc. may be distributed among the client device 40 and the server or cloud environment 50.

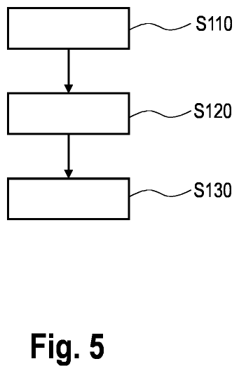

FIG. 5 illustrates in a flow chart a method for determining an onset and/or onset time of a plant disease in agriculture. As before, the method follows the principle as described above and may be applied to any of the above systems illustrated in FIGS. 1 to 4 or a combination thereof.

In a step S110, first data including the field data 14 associated with the plant's cultivation and the weather data 16 associated with a location where said plant is cultivated are provided to the computer model 20. As explained above, the field data 14 may be obtained from the client device 40 or another field site device or observation device or station, may be recorded in a database, or the like. Further, the weather data 16 may be obtained from weather stations, weather data providers, or the like.

In a step S120, by using the computer model 20, a plant disease presence prediction for the plant 12 and its infestation with the plant disease is determined. For example, the data processor 30 may run the computer model 20, or any other suitable computing device.

In a step S130, from the computer model's 20 output including the above plant disease presence prediction and second data, i.e. the vegetation index data 18, including one or more vegetation indices associated with the plant, the onset and/or onset time to which said plant disease is expected to onset at said plant is determined, by using the disease presence prediction and/with a change in the one or more vegetation indices, in particular by aligning the plant disease presence prediction with a change in the one or more vegetation indices.

As explained above, the using the plant disease presence prediction and/with a change in the one or more vegetation indices, in particular the aligning, may be or may comprise applying the above estimation rule to determine the point where there is a presence of the plant disease in the plant disease presence prediction and if there is a change, e.g. an increase or drop, in the one or more vegetation indices as the onset and/or onset time of said plant disease.

Further, as described above, the determined onset and/or the onset time as output data may be used for a plant protection or treatment trigger, alarm and/or schedule.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

1. A computer-implemented method comprising:
providing first data comprising field data associated with cultivation data associated with a plant and weather data associated with a location where said plant is cultivated to a computer model, and determining, by using said computer model, a plant disease presence prediction for said plant and an infestation associated with said plant disease; and
determining, from the plant disease presence prediction outputted by the computer model and from second data comprising one or more vegetation indices associated with said plant, an onset time on which said plant disease is expected to onset at said plant, by using the plant disease presence prediction and a change in the one or more vegetation indices.

2. The method of claim 1, wherein the using the plant disease presence prediction and the change in the one or more vegetation indices comprises:
applying an estimation rule to determine the onset time by determining a presence of the plant disease in the plant disease presence prediction and the change in the one or more vegetation indices.

3. The method of claim 2, wherein the estimation rule is expressed as:
$$\frac{d ( predictions )}{dt} > 0 * \frac{d ( remotesensingindices )}{dt} < 0 ,$$
wherein
$$\frac{d ( predic tions )}{dt}$$
is a gradient of the plant disease presence prediction,
$$\frac{d ( remotesensingindices )}{dt}$$
is a gradient of the one or more vegetation indices, and * is a logical AND operator.

4. The method of claim 1, wherein the using the plant disease presence prediction and said change in the one or more vegetation indices comprises:
convoluting, in the plant disease presence prediction comprising multiple plant disease presence predictions over time, a differential operator over the one or more vegetation indices, and determining a point with the maximum gradient as the onset time of said plant disease.

5. The method of claim 1, wherein the one or more vegetation indices comprise one or more of a normalized difference vegetation index (NVDI), a normalized difference red edge index (NDRE), or a normalized difference water index (NDWI).

6. The method of claim 1, wherein at least one of the second data or the one or more vegetation indices are derived from remote sensing data.

7. The method of claim 6, wherein the remote sensing data is obtained from at least one of one or more satellites or one or more aircrafts.

8. The method of claim 6, wherein the remote sensing data comprises one or more multispectral images.

9. The method of claim 1, wherein the field data comprises information about one or more of a growth stage of the plant, days after sowing the plant, a planting month of the plant, a planting day of year, a location where the plant is cultivated, or previous crop.

10. The method of claim 1, wherein the weather data comprises information about one or more of wind speed, average wind speed, relative humidity, average relative humidity, maximum relative humidity, air temperature, maximum air temperature, precipitation, or minimum air temperature at 5 cm height.

11. The method of claim 1, wherein the computer model is trained with training data fitting the first data without including training data fitting to the second data, prior to the computer model's use of the computer model for plant disease presence prediction.

12. The method of claim 1, wherein at least one of the first data or the second data are provided in tabular structure.

13. The method of claim 1, further comprising:
providing the onset time as output data to be used for at least one of a treatment trigger, alarm or schedule.

14. The use of the onset time determined by the method according to claim 1 to schedule treatment of one or more plants in agriculture.

15. An apparatus comprising:
a data processor; and
a data interface connected to said data processor;
wherein the data interface is configured to receive first data comprising field data associated with cultivation data associated with a plant and weather data associated with a location where said plant is cultivated and second data including one or more vegetation indices associated with said plant;
wherein the data processor is configured to execute a computer model to determine, based on the received first data, a plant disease presence prediction for said plant and its infestation with said plant disease; and
wherein the data processor is configured to determine, based on said computer model output comprising said disease presence prediction and the second data, an onset time to which said plant disease is expected to onset at said plant, by using said disease presence prediction and a change in the one or more vegetation indices.
